(19) United States
(12) Patent Application Publication
(10) Pub. No.: US 2020/0320955 A1
(43) Pub. Date: Oct. 8, 2020

(54) AUGMENTED REALITY SYSTEMS

(71) Applicant: Contrast, Inc., Albuquerque, NM (US)

(72) Inventors: Willie C. Kiser, Albuquerque, NM (US); Michael D. Tocci, Albuquerque, NM (US); Nora Tocci, Albuquerque, NM (US)

(21) Appl. No.: 16/373,752

(22) Filed: Apr. 3, 2019

(51) Int. Cl. G09G 5/00; G02B 27/01; G06F 3/01; A63F 13/52; A63F 13/25; A63G 31/00

(52) U.S. Cl. CPC G09G 5/006; A63F 2300/308; G06F 3/012; G02B 27/0176; A63F 13/52; A63F 13/25; A63G 31/00; G02B 2027/0138; G02B 2027/014; G02B 2027/0178; G09G 2340/02; G09G 2370/16; G09G 2370/022; G09G 2354/00; G02B 2027/015; G02B 2027/0152; G02B 27/0172

(57) ABSTRACT

The invention provides an augmented reality system including a wearable device in the form of a headset for providing a person wearing the headset with an augmented view of a real-world environment. The headset includes a display unit positioned to be within a field of view of a person wearing the headset. The headset further includes a processing subsystem built into the headset and operable to receive a wireless signal comprising compressed augmented reality content from a remote server system and to further display the augmented reality content on the display unit.

### TECHNICAL FIELD

The disclosure relates to augmented reality platforms and devices.

### BACKGROUND

Augmented reality (AR) is a live view of a physical, real-world environment in which elements are “augmented” by computer-generated perceptual information. Unlike virtual reality, which creates a completely artificial environment, augmented reality uses the existing environment and overlays new information on top of it. The overlaid information may be constructive (i.e. additive to the natural environment) or destructive (i.e. masking of the natural environment). In particular, the overlaid, computer-generated information is spatially registered with the physical world such that the overlaid information may be perceived as an immersive aspect of the real environment. As such, augmented reality is intended to alter a user's current perception of a real-world environment, as opposed to virtual reality that replaces the real-world environment with a simulated one.

One of the benefits of augmented reality is that it allows components of the digital world to be brought into a person's perception of the real world through the integration of immersive sensations that are perceived as natural parts of an environment. For example, augmented reality systems may enhance a person's conception of reality through a variety of sensory modalities, such as visual, auditory, haptic, and olfactory. Most augmented reality systems provide a wearable device, generally in the form of a headset to be worn by the person which includes a video or graphic display through which augmented views of the real-world environment are presented to the wearer.

While current systems may be able to provide a person with some form of augmented reality experience, current systems have drawbacks. For example, typical hardware components of a headset include one or more processors, displays, sensors, and input devices for performing the various processes required to create an augmented reality experience. As a result, existing headsets may tend to be bulky and heavy, and generally uncomfortable for the wearer. Furthermore, most, if not all, processes involved in generating an augmented reality visual experience may occur directly on the headset itself or, in some instances, such processes are carried out via a nearby computing device directly connected to the headset. As such, current augmented reality systems are physically limiting, wherein a person's movement and ability to explore their immediate, real-world environment is severely restricted. In turn, current augmented reality systems lack the ability to provide a truly immersive augmented reality experience, particularly in real-world environments in which a person's exploration and movement with such environments is ideal, such as amusement parks and the like.

### SUMMARY

The present invention provides augmented reality systems comprising a wearable device that provides a user with an augmented view of a real-world environment. In a preferred embodiment, a wearable device of the invention is a pair of glasses having minimal on-board hardware. A preferred apparatus of the invention comprises an integrated processing subsystem that is operable to wirelessly communicate and exchange data with a remote server system. A preferred headset further comprises a display unit positioned to be within a field of view of the wearer and to provide the wearer with an augmented view of a real-world environment. Preferably, AR content is transmitted to the headset as compressed files originating in a remote server system. A processing subsystem on the headset performs a decompression operation on the compressed content received from the remote server system for display in the field-of-view of the user.

Accordingly, a headset of the present invention is able to effectively download augmented reality content that has been prepared and compressed by a separate remote server system. The headset component of a system of the invention ideally contains minimal hardware components, which may include processors, sensors and screen components sufficient to decompress received data and project AR content in the field-of-view of the user. In turn, the system requires few processes to be performed by the headset itself. A headset for use in the invention may also transmit information, including video content, position data, location and environmental data, to the remote processor subsystem. The headset and processor subsystem communicate with each other in real time or on a programmed time basis, depending on the desires of the operator. A system of the present invention provides a lightweight, portable solution for a wide variety of augmented reality applications. However, it will be apparent to the skilled artisan that systems of the invention are also useful for the transmission and display of virtual reality content in the same manner as the augmented reality content with the key features of minimal hardware on the headset and wireless communication with a processor subsystem that contains the majority of the processors, storage, electronics and other hardware components not essential for the display of content at the headset.

In certain embodiments of a system of the invention, the headset component comprises a camera. Onboard software causes image data from the headset to be transmitted to the remote processor system. The remote processors use image data from the camera to provide feedback that may cause the processing system to push out new, different, or changed content to a receiver on the headset. In addition, camera data is useful to record user experience for quality assurance, system improvements, safety monitoring and/or to monitor user compliance. In one embodiment, the remote server system provides display drivers for augmented reality content and for the display unit. As noted above, the server system compresses the augmented reality content and transmits the compressed augmented reality content to the wearable headset.

Augmented reality content comprises digital images that are superimposed on real world fields-of-view. Content is stored on the remote server subsystem of objects, composed by the server system, to be superimposed on real-world environmental views (i.e., digital images of an object to displayed as overlays when a wearer is viewing the real-world environment in real-time) or includes a digital view of the real-world environment having digital images superimposed thereon. In certain embodiments of the device, the display unit of the wearable headset comprises transparent glass and built-in digital micro-projector. The augmented reality content comprises images, originating at the remote server system, to be superimposed on real-world environmental views by projection by the micro-projector onto the transparent glass. In certain embodiments, the display unit comprises a digital display screen and the augmented reality content comprises a digital environmental view having images superimposed thereon. The headset may also comprise multiple digital display screens that are positioned to create a 3D view.

In certain embodiments of the invention, a headset further comprises one or more sensors for capturing location, orientation, or field-of-view information of the person wearing the headset. Sensors include, but are not limited to, a camera, a motion sensor (including but not limited to an accelerometer and/or a gyroscope), and a global positioning satellite (GPS) sensor. Augmented reality content may comprise one or more images (which may include one or more objects), originating at the server system, to be displayed as overlays on views of the real-world environment. More specifically, the server system uses the location, orientation, or field-of-view information of the person wearing the headset to compose the augmented reality content in real-time. In certain embodiments, the augmented reality content comprises a game. In certain embodiments, the augmented reality content is selected from the group consisting of a virtual object, a digital image, a digital video, an application, a script, a promotion, an advertisement, a graphic, and an animation.

The invention is applicable to any real-world environment, including but not limited to an amusement park, a stadium or other setting for sporting events, a theater, a concert venue, and other entertainment-related environments.

### BRIEF DESCRIPTION OF THE DRAWINGS

FIG. 1 diagrams an augmented reality system of the present disclosure.

FIG. 2 diagrams the augmented reality system of the present disclosure in greater detail, illustrating the various sensors provided on the wearable headset.

FIG. 3 shows a perspective view of an exemplary wearable headset of the augmented reality system consistent with the present disclosure.

FIG. 4 diagrams augmented reality system of the present disclosure with the exemplary wearable headset.

FIG. 5 shows the display unit of the wearable headset presenting an augmented reality view.

FIG. 6 diagrams a method of providing an augmented reality view.

### DETAILED DESCRIPTION

The present invention provides an augmented reality system including a wearable device in the form of a headset for providing a user with an augmented view of a real-world environment. The headset includes a processing subsystem. The processing subsystem is operable to wirelessly communicate and exchange data with a remote server system. The headset further includes a display unit positioned to be within a field of view of the wearer and to provide the wearer with an augmented view of a real-world environment based on compressed augmented reality content wirelessly received from the remote server system. In particular, the processing subsystem performs a decompression operation on the compressed augmented reality content received from the remote server system and further displays the now decompressed augmented reality content on the display unit. The augmented reality content includes digital images (which may be one or more objects) stored in a server system. Images are wirelessly transmitted to a headset and are superimposed on real-world environmental views (i.e., digital images of an object to displayed as overlays when a wearer is viewing the real-world environment in real time) or may include a digital view of the real-world environment having digital images superimposed thereon.

Accordingly, a headset of the present invention is able to effectively download augmented reality content that has already been prepared and compressed by a remote server system. Systems of the invention require only minimal processing at the headset itself. Rather, the headset merely transmits image and sensor data (location, orientation, or field-of-view information from the real-world environment) to the remote server system, subsequently receives compressed augmented reality content from the remote server system, and performs a decompression operation on the compressed augmented reality content to thereby drive the display unit and provide an augmented view of a real-world environment. In turn, the headset of the present invention is much more manageable by way of size, portability, and operation, ultimately improving the ability for a wearer to move and explore their environment and thus improving the overall augmented reality experience.

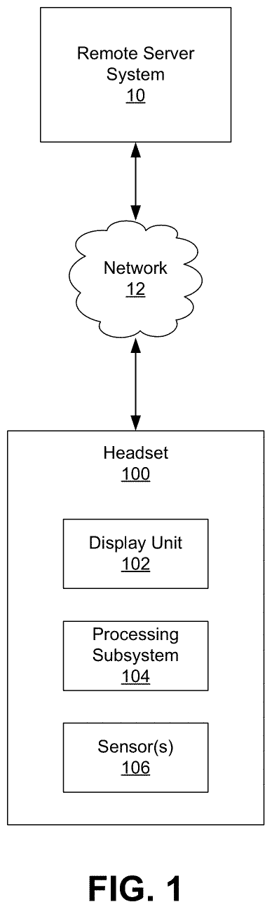

FIG. 1 diagrams an augmented reality (AR) system of the present disclosure, including a remote server system 10 and a wearable headset device 100 operable to communicate and transmit data with one another over a network 12. The network 12 may be any network that carries data. Non-limiting examples of suitable networks that may be used as network 12 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, fifth generation (5G) cellular-based data communication technologies, Bluetooth radio, Near Field Communication (NFC), a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web).

The headset 100 includes a display unit 102 positioned to be within a field of view of a person wearing the headset (i.e., the “wearer”) and a processing subsystem 104 built into the headset 100 and configured to wirelessly communicate with the remote server system to receive augmented reality (AR) content to be displayed on the display unit 102. The processing subsystem 104 includes, for example, a hardware processor coupled to non-transitory, computer-readable memory containing instructions executable by the processor to cause the processing subsystem 104 to wirelessly communicate with the remote server system 10 over the network 12 and exchange data therewith. For example, the processing subsystem 104 is operable to receive a wireless signal comprising compressed augmented reality content from the remote server system 10 over the network 12 and display the augmented reality content on the display unit 102.

As previously described, the headset 100 is able to receive AR content that has already been prepared and compressed by the separate remote server system 10, thereby offloading to the remote server system 10 most if not all of the calculations, processing, database reading, rendering, and computations (and their concomitant size, weight, power, and heat generating attributes) needed to generate this content. For example, the remote server system 10 may generally include hardware and software for receiving information from the headset 100, including, but not limited to, location, orientation, or field-of-view information from the real-world environment. Such information is associated with data from one or more sensors associated with the headset 100.

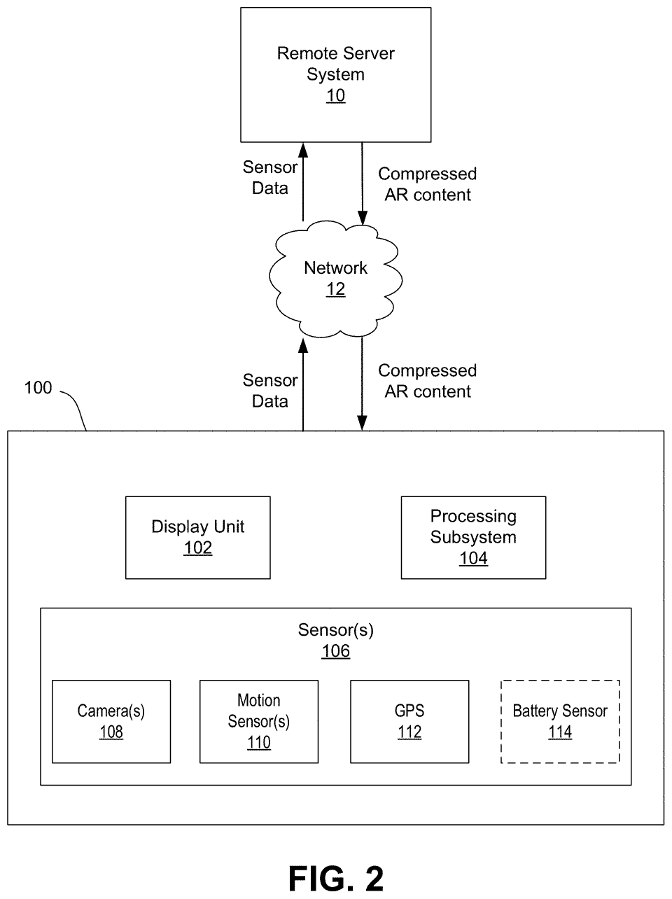

For example, FIG. 2 diagrams the augmented reality system in greater detail, illustrating the various sensors 106 provided on the wearable headset 100. As shown, the headset 100 may include a variety of sensors for capturing data related to at least one of a location of the wearer within the real world environment, a point of gaze of the wearer within the real world environment, a field of view of the wearer within the real world environment, and a physical setting and objects within the real world environment. The sensors 106 may include one or more of a camera 108, motion sensor 110, and global positioning satellite (GPS) sensor 112. Optionally, the headset 100 may further include a battery sensor 114 for sensing a power level of a battery for powering components of the headset 100, such as the display unit 102, processing subsystem 104, and one or more of the sensors 106. The camera 108 is operable to capture one or more images (or a series of images) of the real-world environment. The motion sensor 110 may include an accelerometer, an altimeter, one or more gyroscopes, other motion or movement sensors to produce sensory signals corresponding to motion or movement of the headset 100 and the wearer, and a magnetometer to produce sensory signals from which direction of travel or orientation of the headset 100 (i.e., the orientation of the wearer) can be determined.

The processing subsystem 104 transmits sensor data, including images or other information related to the wearer, to the remote server system 10. In turn, the remote server system processes the sensor data in accordance with AR-based processes and in accordance with AR software, such as AutoCad3D, StudioMax or Cinema4D programs. The AR processing may be recognition-based augmented reality or location-based augmented reality, or a combination of both, as generally understood. The AR processing may also optionally include a predictive calculation method, such as Kalman filtering or Linear Quadratic Estimation, to help reduce overall system latency. The remote server system 10 may then obtain and/or create AR content, which may be in the form of one or more images including one or more objects, composed by the server system 10, to be displayed as overlays on views of the real-world environment. In particular, server system 10 uses the location, orientation, or field-of-view information of the wearer to compose the AR content in real-time. Accordingly, the sensor data is important and is relied upon by the remote server system 10, which is able to generate and reposition AR content according to a location of the wearer within the real-world environment, as well as a position of the wearer's head with regards to objects within the real-world environment. The headset 100 effectively immerses the wearer in the augmented reality experience, because elements of the augmented reality scene are updated and received on-the-fly.

As previously described, the AR content includes one or more images including one or more objects, composed by the server system 10, to be displayed as overlays on views of the real-world environment. For example, the images may include low-dynamic range (LDR) and/or high-dynamic range (HDR) images. Accordingly, the remote server system 10 may either take an LDR series of images that represent a video stream, for example, and compress the series of images using JPEG, or slog, or may take an HDR series of images and compress it using JPEG. The use of JPEG for compression techniques minimizes latency for use with augmented reality. The remote server system 10 may rely on HDR10 format, for example, or any other means of reducing an HDR signal to LDR bit widths. However, if the AR content includes LDR images, first stage compression is unnecessary. Any generalized form of image compression standard and coding system can be used. For example, the image compression standard for compressing the AR content may include, but is not limited to, JPEG2000, MP4, and/or H.265 image compression standards.

Upon compressing the AR content, the remote server system 10 transmits the compressed AR content to the headset 100 over the network 12. While the transmission is described as being wireless and is preferred as wireless for advantages, it should be noted that, in some embodiments, transmission may be via a wired transmission protocol. For example, in some embodiments, the transmission of data between the headset 100 and the remote server system 10 occurs over an Ethernet transmission, USB, or other wired connection. An advantage of using Ethernet for wired transmission is that the headset 100 can be powered via Power Over Ethernet (PoE). However, as previously described, the preferred transmission protocol is wireless communication, which provides for greater range of mobility for the wearer, particularly in environments in which roaming a setting is encouraged (i.e., an amusement park, sporting event, etc.).

The processing subsystem 104 receives the compressed AR content and subsequently performs a decompression operation on the compressed AR content to thereby drive the display unit 102 and provide an augmented view of a real-world environment. In the event that the AR content comprises HDR images, the decompression step includes decompressing the JPEG images in real-time by de-slogging the image. However, decompression of compressed images can be generalized to other forms of HDR and LDR conversion, such as the HDR10 compression standard.

The headset 100 may provide direct or an indirect live view of a physical, real-world environment wherein elements are “augmented” by computer-generated perceptual information received from the remote server system 10. The term “real-world environment” is generally understood to mean the immediate and surrounding environment, including ground, horizon, sky, objects, and other features existing or occurring in reality, as opposed to a fictional environment and/or objects. For example, with a direct live view, the display unit 102 may include at least a first lens for a right eye and a second lens for a left eye, wherein each lens includes a transparent glass and further includes a digital micro-projector. Accordingly, when wearing the headset, the wearer can still view the real-world environment through the transparent glass and further view AR content received from the remote server system 10 that is projected via the digital micro-projector onto the glass such that objects associated with the AR content can be seen in the real-world environment.

For an indirect live view, the display unit 102 may include a digital display screen for each of the first and second lens (i.e., the first lens comprises a first digital display and the second lens comprises a second digital display). The AR content includes a digital view of the real-world environment (as a result of image data captured by a camera of the headset 100 and transmitted to the remote server system 10) and further includes AR objects superimposed on the digital view of the real-world environment. In such an embodiment, the two digital display screens may be positioned so as to create a three-dimensional view for the wearer.

The digital micro-projectors and digital displays may include, but are not limited to, a light-emitting diode (LED) projector and/or display, an organic light-emitting diode (OLED) projector and/or display, a liquid crystal display (LCD), a liquid crystal on silicon (LCOS) projector and/or display, and a microdisplay and/or microprojector.

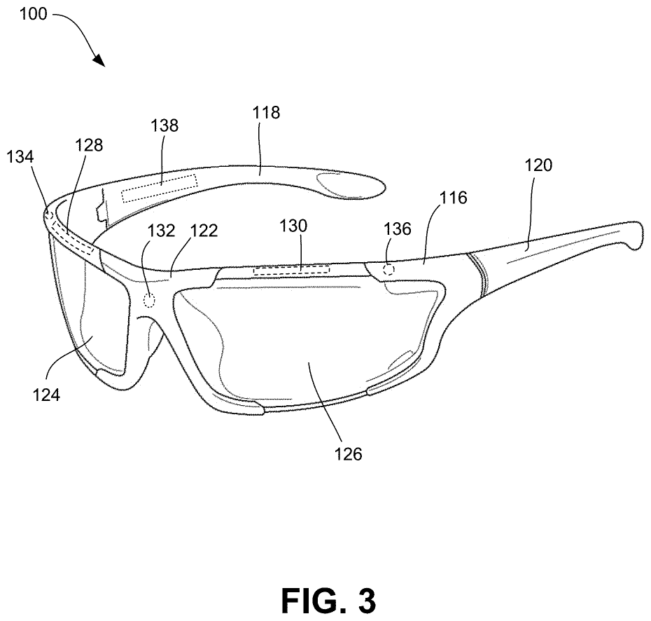

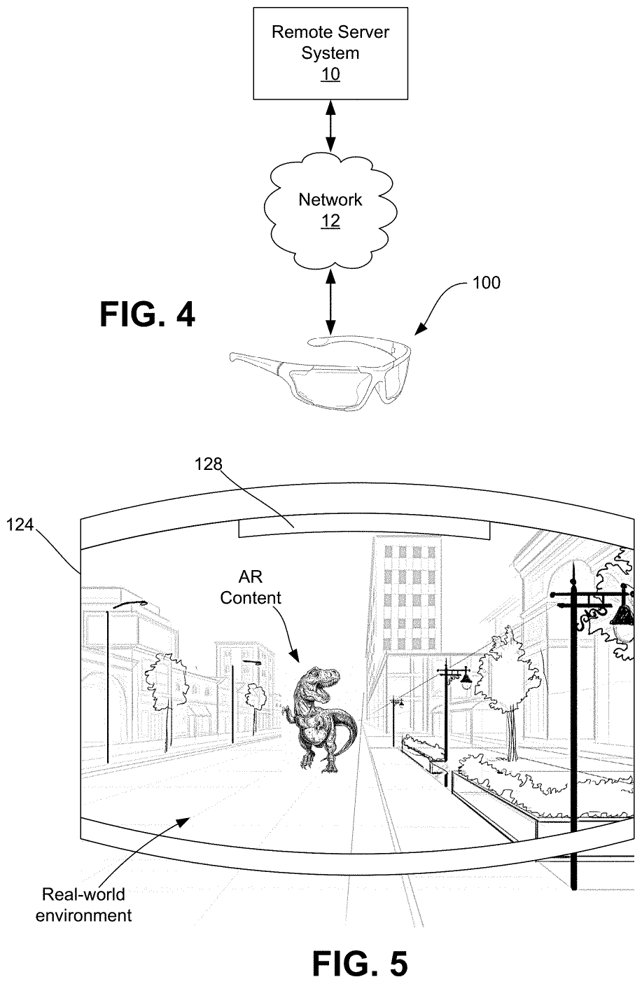

FIG. 3 shows a perspective view of an exemplary wearable headset 100 and FIG. 4 diagrams augmented reality system of the present disclosure with the exemplary wearable headset 100. As illustrated, the headset 100 is generally in form of a pair of eyewear. The headset 100 includes a frame member 116 including a right earpiece 118 and a left earpiece 120, which may be fixedly or hingedly attached to the frame member 116. The frame member 116 further includes a center bridge 122. The headset 100 includes a first lens 124 (e.g., as a right lens) and also includes a second lens 126 (e.g., as a left lens) to provide binocular vision. The right lens 124 and left lens 126 are mounted to the frame member 116. The headset 100 may be dimensioned to be worn on a human head, with each earpiece extending over a respective ear such that a portion of the frame member 116 extends across the human face. The right lens 124 and left lens 126 may be mounted to the frame member 116 such that, when the headset 100 is worn, each of the right lens and left lens 124, 126 is disposed in front of a the respective eyes of the wearer. As previously described, the headset 100 may include one or more sensors 132, 134, 136, and 138, such as camera(s), microphone(s), motion sensor(s), GPS sensor(s), and the like, for capturing/sensing data associated with the location, orientation, or field-of-view information of the person wearing the headset 100 to compose the augmented reality content in real-time. Furthermore, in certain embodiments, the headset 100 includes one or more of electronic displays or projectors 128, 130 for each of the right lens and left lens 124, 126, as previously described herein.

FIG. 5 shows the right lens 124 of the wearable headset 100 presenting an augmented reality view to a wearer. As shown, a wearer can see the real-world environment and also see AR content, representing an augmented reality. In particular, in this embodiment, the display unit 102, particularly the lens 124, is providing a direct live view, in which the lens 124 includes a transparent glass and further includes a digital micro-projector 128. Accordingly, when wearing the headset 100, the wearer can still view the real-world environment through the transparent glass and further view AR content (i.e., illustrated as a dinosaur) received from the remote server system 10 that is projected via the digital micro-projector 128 onto the glass such that objects associated with the AR content can be seen in the real-world environment. It should be noted that, in some embodiments, the display unit 102, particularly the lens 124, may provide an indirect live view, in which the lens 124 includes a digital display screen 128. Accordingly, when wearing the headset, the AR content includes a digital view of the real-world environment (as a result of image data captured by a camera of the headset 100 and transmitted to the remote server system 10) and further includes AR objects superimposed on the digital view of the real-world environment. In such an embodiment, the two digital display screens may be positioned so as to create a three-dimensional view for the wearer.

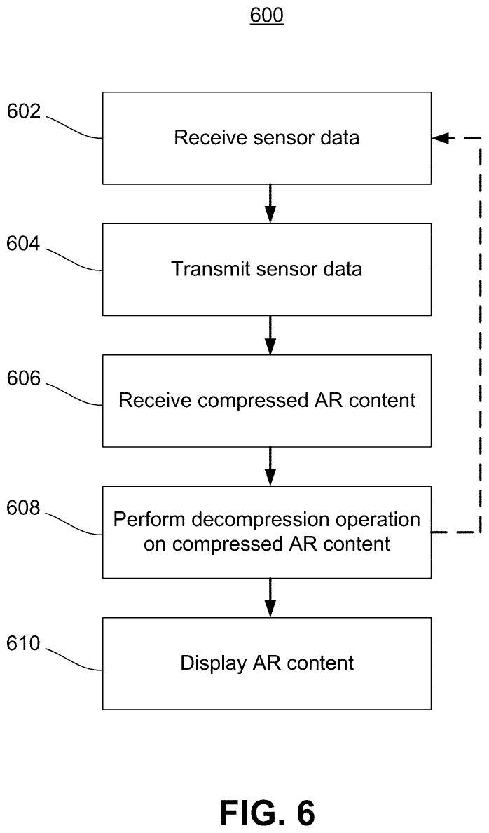

FIG. 6 diagrams a method 600 of providing an augmented reality view. The method 600 includes receiving, via a processing subsystem of a wearable headset, sensor data from one or more sensors built into, or otherwise associated with, the wearable headset (operation 602). The one or more sensors are for capturing location, orientation, or field-of-view information of the person wearing the headset. The one or more sensors may include, but are not limited to, camera(s), motion sensor(s), and global positioning satellite (GPS) sensor(s). The method 600 further includes transmitting, via the processing subsystem, the sensor data to a remote server system (operation 604). Transmission of the sensor data occurs preferably via a wireless transmission protocol, such as, for example, a Wi-Fi wireless data communication technology, Bluetooth radio, or Near Field Communication (NFC).

The method 600 further includes receiving, via the processing subsystem, compressed AR content (operation 606). As previously described, the remote system server is operable to process the sensor data in accordance with AR-based processes and in accordance with AR software, such as AutoCad3D, StudioMax or Cinema4D programs. The AR processing may be recognition-based augmented reality or location-based augmented reality, or a combination of both, as generally understood. The AR processing may also optionally include a predictive calculation method, such as Kalman filtering or Linear Quadratic Estimation, to help reduce overall system latency. The remote server system 10 may then obtain and/or create AR content, which may be in the form of one or more images including one or more objects, composed by the server system, to be displayed as overlays on views of the real-world environment. In particular, server system uses the location, orientation, or field-of-view information of the wearer to compose the AR content in real-time. Accordingly, the sensor data is important and is relied upon by the remote server system, which is able to generate and reposition AR content according to a location of the wearer within the real-world environment, as well as a position of the wearer's head with regards to objects within the real-world environment. The AR content is compressed by any known image compression standard. The method 600 further includes performing, via the processing subsystem, a decompression operation on the compressed AR content (operation 608) and displaying, via a display unit of the headset, AR content (operation 610).

Accordingly, a headset of the present invention is able to receive augmented reality content that has already been prepared and compressed by the separate remote server system, thereby offloading to the remote server system 10 most if not all of the calculations, processing, database reading, rendering, and computations (and their concomitant size, weight, power, and heat generating attributes) needed to generate this content. In turn, the system requires few processes to be performed by the headset itself. Rather, the headset merely transmits image and sensor data (location, orientation, or field-of-view information from the real-world environment) to the remote server system, subsequently receives compressed augmented reality content from the remote server system, and performs a decompression operation on the compressed augmented reality content to thereby drive the display unit and provide an augmented view of a real-world environment. In turn, the headset of the present invention is much more manageable by way of size, portability, and operation, ultimately improving the ability for a wearer to move and explore their environment and thus improving the overall augmented reality experience.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. An augmented reality device comprising:
a wearable headset comprising a display unit positioned to be within a field of view of a person wearing the headset; and
an integrated processing subsystem built into the headset, the processing subsystem comprising a hardware processor coupled to non-transitory, computer-readable memory containing instructions executable by said processor to cause said processing subsystem to:
receive, from a separate remote server system over a network, a remote signal comprising compressed augmented reality (AR) content including compressed low-dynamic range (LDR) and/or high-dynamic range (HDR) images;
decompress, via a decompression operation specific to the underlying compressed AR content, the compressed AR content; and
display the decompressed AR content on the display unit.

2. The device of claim 1, wherein the processing subsystem receives the compressed augmented reality content over a wireless transmission.

3. The device of claim 2, further comprising a camera.

4. The device of claim 3, wherein the processing subsystem receives image data from the camera and wirelessly transmits the image data to the server system.

5. (canceled)

6. The device of claim 1, wherein the server system compresses the augmented reality content and transmits the compressed augmented reality content to the wearable headset.

7. The device of claim 1, wherein the display unit comprises transparent glass and a digital micro-projector built into the wearable headset.

8. The device of claim 7, wherein the augmented reality content comprises images, composed by the server system, to be superimposed on real-world environmental views by projection by the micro-projector onto the transparent glass.

9. The device of claim 1, wherein the display unit comprises a digital display screen and the augmented reality content comprises a digital environmental view having images superimposed thereon.

10. The device of claim 9, further comprising two digital display screens positioned to create a 3D view.

11. The device of claim 1, further comprising one or more sensors for capturing location, orientation, or field-of-view information of the person wearing the headset.

12. The device of claim 11, wherein the one or more sensors are selected from the group consisting of a camera, a motion sensor, and a global positioning satellite (GPS) sensor.

13. The device of claim 12, wherein the motion sensor comprises an accelerometer or a gyroscope.

15. The device of claim 11, wherein the augmented reality content comprises one or more images including one or more objects, composed by the server system, to be displayed as overlays on views of the real-world environment.

16. The device of claim 15, wherein the server system uses the location, orientation, or field-of-view information of the person wearing the headset to compose the augmented reality content in real-time.

17. The device of claim 15, wherein the augmented reality content comprises a game.

18. The device of claim 15, wherein the augmented reality content is selected from the group consisting of a virtual object, a digital image, a digital video, an application, a script, a promotion, an advertisement, a graphic, and an animation.

19. The device of claim 1, wherein the real-world environment is associated with an area of interest or attraction.

20. The device of claim 19, wherein the real-world environment is associated with an amusement park.
